(19) United States
(12) Patent Application Publication
(10) Pub. No.: US 2014/0057230 A1
(43) Pub. Date: Feb. 27, 2014

(54) APPARATUS FOR TEACHING COMMUNICATION SKILLS

(71) Applicant: MARY BUCHANAN PROPPER, Sanford, FL (US)

(72) Inventor: MARY BUCHANAN PROPPER, Sanford, FL (US)

(21) Appl. No.: 13/966,586

(22) Filed: Aug. 14, 2013

Related U.S. Application Data
(60) Provisional application No. 61/691,887, filed on Aug. 22, 2012.

(51) Int. Cl. G09B 21/00

(52) U.S. Cl. CPC G09B 21/00
USPC 434/112

(57) ABSTRACT

A visually impaired person may be taught verbal communication skills using specimen display assemblies that present tactile specimens representing words that are to be learned. The specimens are attached to and project from a surface of a specimen display card. The specimen display card may be used in conjunction with a teaching device such as an easel or an electronic device having a touch sensitive surface and a speaker, whereby the electronic device broadcasts a programmed verbal message from the speaker when a force is imparted to the touch sensitive surface.

This is a nonprovisional Patent Application that claims priority of provisional U.S. Patent Application 61/691,877 filed 22 Aug. 2012 which is incorporated herein by reference in its entirety.

### FIELD OF THE INVENTION

The present invention relates to an apparatus for teaching communication skills to a person that is impaired visually or cognitively.

### BACKGROUND OF THE INVENTION

A person that can benefit from the present invention may be totally blind or have so little vision that they are unable to see objects that they will come into contact with on a daily basis. Other persons that can benefit from the present invention are persons that have difficulties associating a picture or other symbol with the actual object represented by the picture or other symbol. For example, a person that is visually impaired at birth or from a time prior to the development of speech, may have extreme difficulty developing speech skills because they cannot see an object then learn to associate the making of an appropriate sound to identify the object. A teacher may work with persons having the aforementioned impairments to teach the association of the feel of an object with a word, or words, which identify the object. As used herein and in the claims the term teacher includes parents or other caregivers. The present invention is not intended as a replacement for Braille, but rather as another tool to be used in teaching communication skills.

### DISCUSSION OF THE PRIOR ART

Devices that are currently used for teaching communication skills, specifically speaking and hearing skills, include devices that display printed representations of shapes or objects and asking a student to press on the object causing the device to broad cast the word that describes the object. Such a device is available for example from Enabling Devices, 50 Broadway, Hawthorne, N.Y. 10532, www.enablingdevices.com. Another device used for teaching a student to learn to associate a picture of a shape or object with a word is to display the picture on a presentation surface such as an easel and then ask the student to point at the picture and say the correct word for the shape or object. These methods of teaching communication skills may work fine for a student that is able to clearly see the shape or object represented, but is not appropriate for a student that is totally blind or has so little vision that he is unable to see the symbol presented on the card. The present invention provides a means for teaching verbal communication skills to such vision impaired students.

### SUMMARY OF THE INVENTION

There is provided in accordance with one aspect of the present invention an apparatus for teaching communication skills comprising: (a) a specimen display card; (b) an object that is attached to and projects from a first surface of the specimen display card and can be felt by a student to determine what the object represents; and (c) a second surface of the specimen display card disposed opposite the first surface and being attachable to a device used for teaching communication skills.

There is provided in accordance with another aspect of the present invention a system for teaching communication skills comprising: (a) an electronic device having a touch sensitive surface and a speaker, the electronic device broadcasting a programmed verbal message from the speaker when a force is imparted to the touch surface; and (b) at least one apparatus that can be placed in communication with the touch sensitive surface comprising a flexible specimen display card with an object that is attached to and projects from a first surface of the specimen display card and can be felt by a student to determine what the object represents, a second surface of the specimen display card disposed opposite the first surface and being configured to be placed adjacent to the touch sensitive surface of the electronic device whereby pushing on the first surface of the specimen display card imparts a force to the touch surface.

There is provided in accordance with another aspect of the present invention a system for teaching communication skills comprising: (a) a presentation device such as an easel having a presentation member having a presentation surface; and (b) at least one apparatus that can be placed in communication with the presentation surface of the presentation member comprising a specimen display card with an object that is attached to and projects from a first surface of the specimen display card and can be felt by a student to determine what the object represents, a second surface of the specimen display card disposed opposite the first surface and being configured to be fixed to the presentation surface of the presentation device.

### BRIEF DESCRIPTION OF THE DRAWINGS

FIG. 1 is a schematic representation of a perspective view of a first exemplary prior art device for teaching communication skills.

FIG. 2 is a schematic representation of an elevation view of the exemplary device of FIG. 1 looking in the direction of arrow A in FIG. 1.

FIG. 3 is a perspective schematic representation of a second exemplary prior art device for teaching communication skills.

FIG. 4 is a perspective view of an exemplary specimen display card according to the present invention with a specimen mounting member fixed to a first surface of the specimen display card.

FIG. 5 is a plan view of the exemplary specimen display card of FIG. 4 showing a side of the specimen display card that is apposite the side shown in FIG. 4.

FIG. 6 is a perspective view of an exemplary specimen display assembly having a specimen display card with a specimen that emulates the size and surface texture of a cheese cracker fixed to the specimen display card.

FIG. 7 is a perspective view of an exemplary specimen display assembly having specimen display card with an upper portion of a milk or juice carton fixed to the specimen display card.

FIG. 8 is a side elevation view of the exemplary specimen display assembly of FIG. 7.

FIG. 9 is another side elevation view of the exemplary specimen display assembly of FIG. 7.

FIG. 10 is a perspective view of an exemplary specimen display assembly having a cup fixed to the specimen display card.

FIG. 11 is a side elevation view of the exemplary specimen display assembly of FIG. 10.

FIG. 12 is a perspective view of an exemplary specimen display assembly with a specimen display card having a transparent plastic bag attached to the specimen display card, the plastic bag containing a specimen such as a gummy worm.

FIG. 13 is a perspective view of an exemplary specimen display assembly with a specimen display card having a transparent plastic sheet attached to the specimen display card and a specimen is disposed between the film and the first surface of the specimen display card.

FIG. 14 is a perspective view of an exemplary specimen display assembly with the specimen attached to the specimen display card by an elongated member.

FIG. 15 is an exemplary schematic perspective view of the device for teaching communication of FIGS. 1 and 2 assembled with exemplary specimen display assemblies according to FIGS. 6-12.

FIG. 16 is an exemplary schematic perspective view of a device for teaching communication of FIG. 3 assembled with exemplary specimen display assemblies according to FIGS. 6-12.

### DETAILED DESCRIPTION OF THE INVENTION

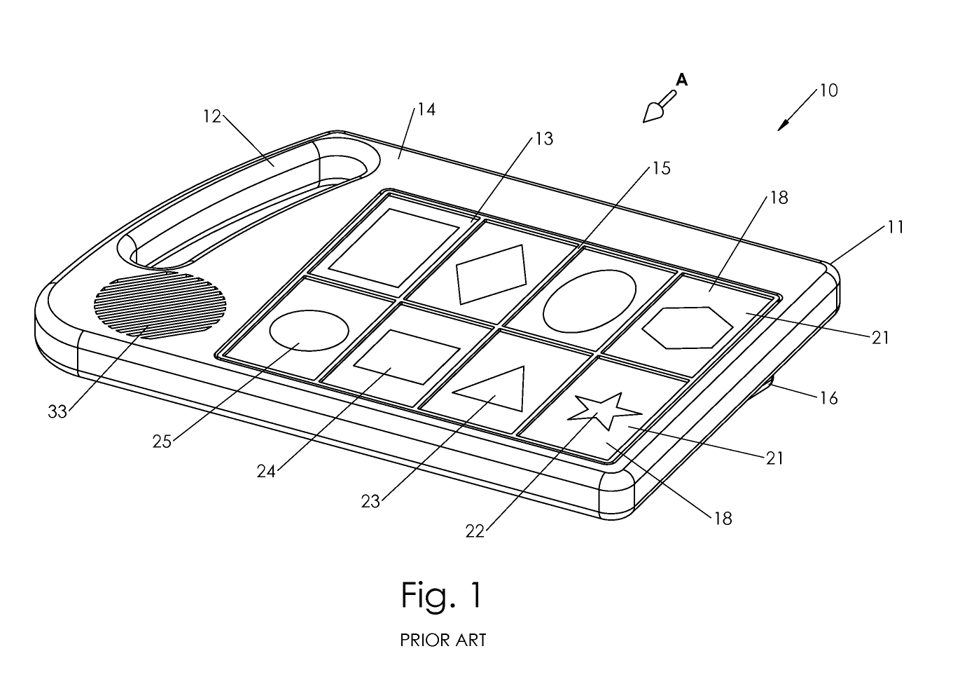

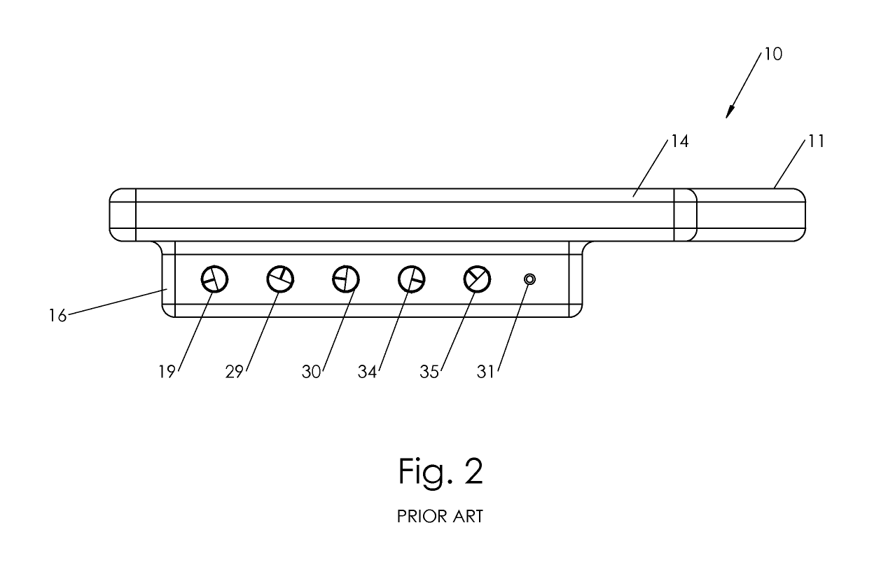

Referring to FIG. 1 there is shown a schematic representation of a perspective view of an exemplary prior art device 10 for teaching communication skills. FIG. 2 is a schematic representation of an elevation view of the exemplary device of FIG. 1 looking in the direction of arrow A in FIG. 1. Such a device is available for example from Enabling Devices, 50 Broadway, Hawthorne, N.Y. 10532, www.enablingdevices.com. The teaching device 10 has a case 11 provided with a carrying handle 12. A touch sensing surface 13 is located on an upper surface 14 of the teaching device 10. A replaceable frame 15 provides a grid overlying the touch sensing surface. In the example shown the frame 15 defines eight cells 18, that is to say the touch screen is divided into eight separate touch sensing zones. Replaceable frames are available with grids that divide the touch screen in from one to any chosen number of touch sensing zones in accordance with the specifications of the manufacturer and the end user. In FIG. 1 a plurality of cards 21 are located in the cells 18 defined by the replaceable frame 15. In the prior art these cards 21 are flat with representations that are not raised of various geometric shapes such as a star 22, a triangle 23, a square 24 or a circle 25.

In the exemplary teaching device of FIGS. 1 and 2 a control module 16 that doubles as a support is located on a lower side of the teaching device 10 and facilitates the inclination of the upper side 14 of the teaching device when the teaching device is supported by a level surface. The control module 16 is associated with a power source such as a battery or capacitor, or may communicate with an external power source that may power the teaching device or charge the internal battery or capacitor via a power port 31. An on/off switch 29 is used to boot up or shut down the teaching device. A selector mechanism 19 is used to coordinate the number of cells defined by the replaceable grid with the corresponding number and locations of touch sensing zones to be provided by the touch sensing surface 13. A volume control mechanism 30 controls the volume at which words are recorded on the device and broadcast by device as sounds using a speaker/microphone device 33.

After placing the replaceable grid 15 in a position overlying the touch sensitive surface 13 and placing the prior art cards that present symbols in the cells 18, the teacher may power up the teaching device using the on/off switch 29 then set the device to have the correct number of touch sensing zones using the selector mechanism 19. The teacher may then select a recording volume using the volume control mechanism 30. The teacher may then select the zone for which a word is to be recorded using the zone selector mechanism 35 and speak the appropriate word for the symbol presented by the card overlying that zone of the touch sensitive surface. For example the zone that is overlaid by a card presenting a circle is selected and the teacher speaks the word “circle” into the microphone. After all the necessary recordings have been made by the teacher the student may exert pressure with a finger on the card presenting the circle and will hear the word “circle” broadcast by the speaker 33. The student could then attempt to say the word “circle”. Alternatively the teacher may ask the student to point at a circle and press on the card, if the student responds correctly they will hear the word “circle” broadcast by the speaker 33. This method of teaching communication skills may work fine with for a student that is able to clearly see the symbol presented on a card, but is not appropriate for student that is totally blind or has so little vision that they are unable to see the symbol presented on the card. Furthermore this method of teaching may not be appropriate for a student that has difficulty associating a visual symbol with a word identifying the symbol. The present invention provides specimen display cards that emulate the feel of an object allowing students to feel a specimen, press on the card, and hear the teaching device broadcast the word that is associated with the specimen. As used herein and in the claims the term “specimen” is understood to have its common meaning of “an example of something”.

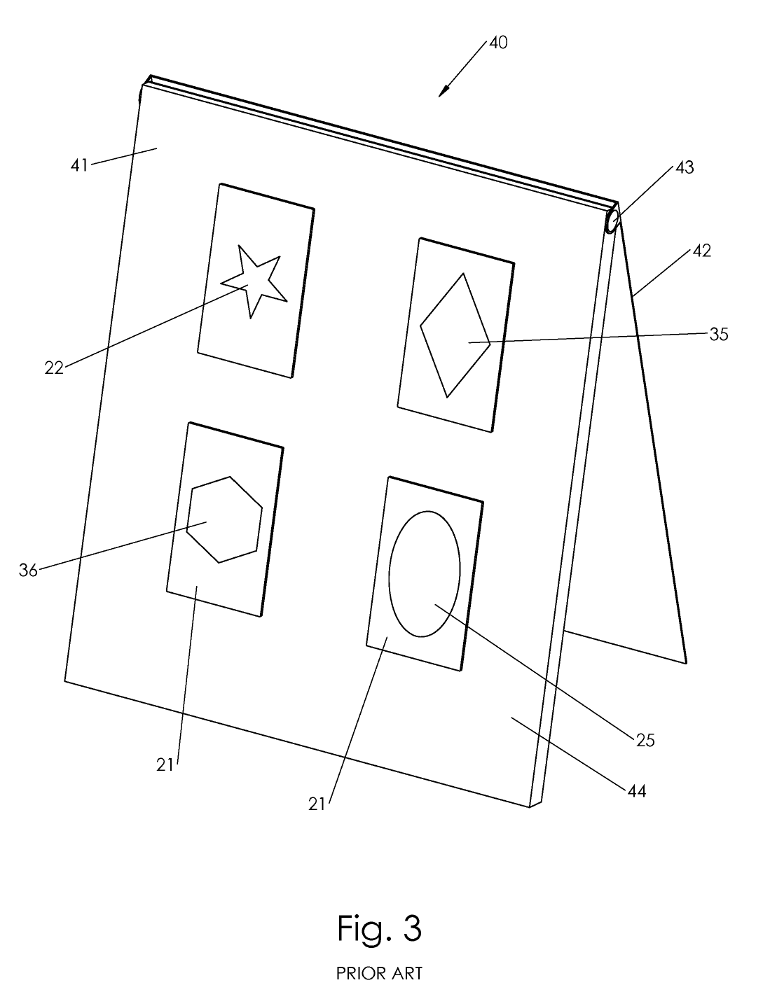

FIG. 3 is a perspective view of a second exemplary prior art device 40 for teaching communication skills. In this example the device for teaching communication skills is an easel 40 having a support member 42 fixed to a presentation member 44 by a hinge. It is understood that the presentation member could be supported in any desirable manner such as a frame hung on a wall. The presentation member may be covered by a felt cloth or could comprise a ferrous member. Cards 21 of the type described with regards to FIGS. 1 and 2 may be fixed to the presentation member using appropriate means such as hook fabric or magnets on the back sides of the cards. Again the cards 21 may present symbols such as a star 22, a circle 25, a diamond 35 or a hexagon 36. The symbols presented by the cards are not raised, so a student cannot feel the symbol. The teacher may point at the card having a circle thereon, and say the word “circle” and ask the student to say the word “circle”. The teacher may ask the student to point at a circle and say the word “circle”. Alternatively the student may be asked to point at any symbol and say the word that it represents. This method of teaching communication skills may work fine with for a student that is able to clearly see the symbol presented on a card, but is not appropriate for student that is totally blind or has so little vision that they are unable to see the symbol presented on the card. Furthermore this method of teaching may not be appropriate for a student that has difficulty associating a visual symbol with a word identifying the symbol. The present invention provides specimen display cards that emulate the feel of an object allowing students to feel a specimen, hear the teacher say the word that is associated with the specimen, and then the student can attempt to say the word he heard the teacher say.

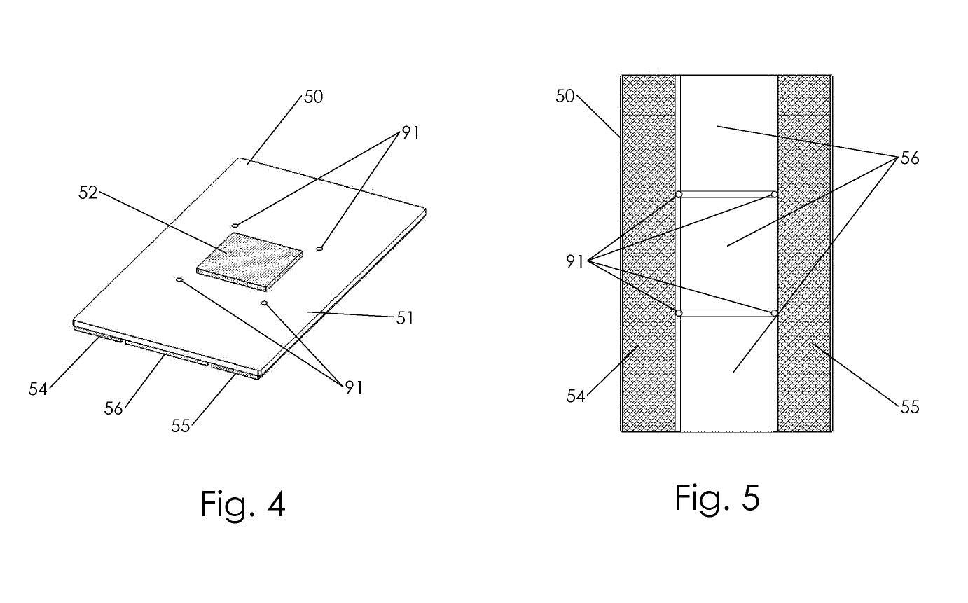

FIG. 4 is a perspective view of a specimen display card 50 according to the present invention. FIG. 5 is a plan view of the specimen display card of FIG. 4 showing a side of the specimen display card that is opposite the side shown in FIG. 4. An exemplary specimen display card comprises a flexible polymeric material and is about eight and a half centimeters by five and a half centimeters, with a thickness of about one half of a millimeter or greater, but preferably thick enough so the specimen display card cannot be distorted by a student to such an extent that a specimen mounted on the card is dislodged. As used herein and in the claims the term “flexible” is understood to have its common meaning of “being able to bend easily and snapping back readily without breaking”. It is understood that a specimen display card used in the practice of the present invention may comprise any suitable material, such as poster board, heavy paper, fabric, an elastomer, or even a thin flexible metal blank. If desired, a specimen mounting member 52 may be fixed to a first surface 51 of the specimen display card. An example of a specimen mounting member is an adhesive with a releasable sheet covering the side of the specimen mounting member that is distal from the specimen display card. As shown in FIG. 5 a second surface of the specimen display card, opposed to the first surface 51, may be provided with at least one means for fixing the specimen display card to a display surface of a device for teaching communication skills. Examples of prior art teaching devices that may be used in the practice of the present invention have been described above with respect to FIGS. 1-3. Examples of means for fixing the specimen display card to a display surface of a device for teaching communication skills include, but are not limited to, at least one strip 54, 55 of hook material attached to the second surface of the specimen display card and/or at least one strip or patch 56 of polymeric magnet material attached to the second surface of the specimen display card. As shown in FIGS. 4 and 5 the specimen display card is provided with at least two, and preferably four, passages 91 therethrough that may be used in securing a specimen using a formable elongated member. It is understood that the specimen display card may be attached to a display surface of a suitable teaching device by any suitable means, including even placing the card in grooves designed for retaining the card, an adhesive, mounting hooks and so forth. The cards may be designed to fit a variety of communication devices. Each communication device may have different sized grids or panels, so the cards need to fit on each. A specimen display card about the size of a credit card) fits most, but not all currently available communication devices. Advantageously, the specimen display cards would be provided in three different sizes (small, med, large), to offer more accessibility to various communication devices.

There are numerous items that can be the subject of communication lessons employing the present invention. For example, without limitation, a student may be motivated to learn to express his desire for items he encounters on a regular basis such as tools used in the educational environment or food. It is desirable to enable a blind or severely visually impaired person, or a person that cannot readily associate visual images of symbols with words associated with those symbols, to be able to express their desire for a particular item of food. In a school environment a good starting point for using the present invention is to teach a student to verbally identify nutritional items that are served with breakfasts, lunches or snacks.

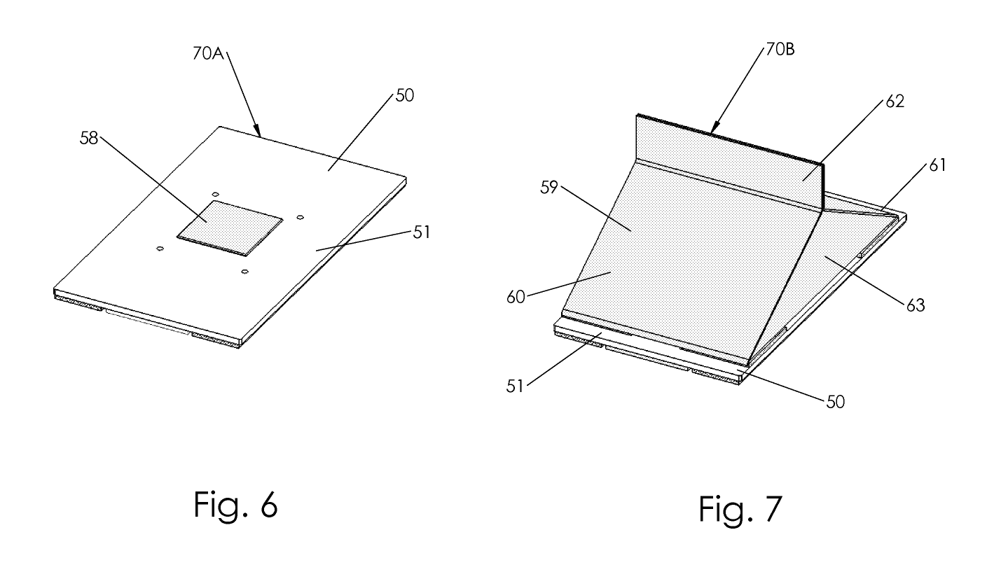

FIG. 6 is a perspective view of an exemplary specimen display assembly 70A comprising a specimen display card 50 with a specimen 58 that emulates the size and surface texture of a cheese cracker fixed to a first surface 51 the specimen display card. If desired a word or words associated with the object to be identified by the student may be presented on the first surface of the specimen display card in Braille. If the object that is to be the subject of a lesson in communications is a specimen of food there is the downside that food may deteriorate over time when repeatedly touched by a student. It has been found that longer lasting specimens that emulate the feel and texture of a food item, such as a cheese cracker are preferable. An object that is a food consumed by a student, and is liked by the student, such as a cheese cracker may be selected for use with the communication device. A mold of the object, such as a cheese cracker, is made using a thermoform process. This is done using dental plaster, and mixing the dental plaster with an acrylic polymer instead of water. It was found that by adding the acrylic polymer to the mixture instead of water the resultant specimen will adhere to the display card better. After the molded specimen dries it is sealed with tan acrylic to make the specimen waterproof so it can be wiped clean between uses by students. The specimen can be adhered to the specimen display cad with an industrial grade, weather proof mounting tape or any other suitable mounting method.

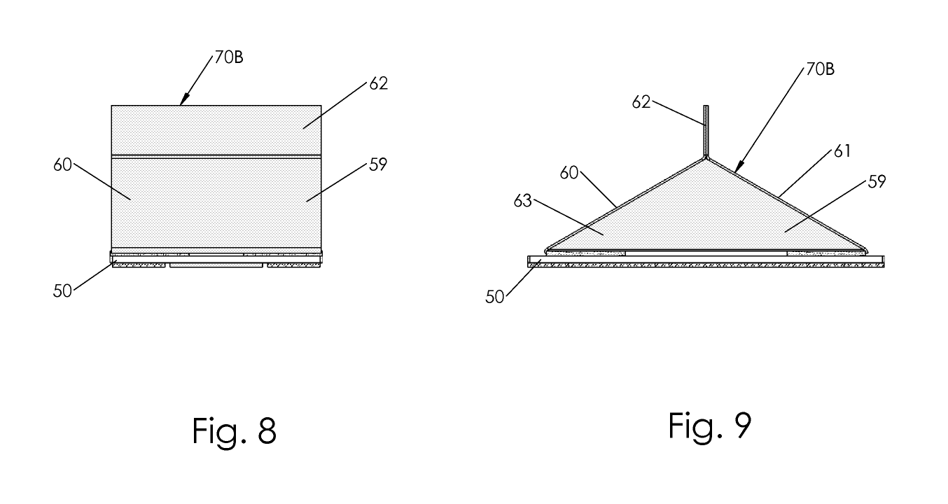

Specimens of some nutritional products, for example milk or juice may be too messy to handle on a regular basis. It is more practical that such nutritional products be identified by their packaging. FIG. 7 is a perspective view of an exemplary specimen display assembly 70B having specimen display card 50 with an upper portion 59 of a milk or juice carton fixed to a first surface 51 the specimen display card. FIG. 8 is a side elevation view of the exemplary specimen display assembly 70B of FIG. 7. FIG. 9 is another side elevation view of the exemplary specimen display assembly 70B of FIG. 7. The upper portion 59 of a milk or juice carton fixed to the first surface 51 the specimen display card by any suitable means such as an adhesive. If desired a word or words associated with the object to be identified by the student may be presented on the first surface of the specimen display card in Braille. A student can learn to identify the carton that contains milk or juice by feeling the inclined top walls 60, 61 of the carton that are joined to one another by a vertically and longitudinally extending seam 62. The alcoves 63 defined by the folding of the walls of the container, including the inclined top walls 60, 61 may also help the student to identify the milk or juice container. If a student will be served milk, then the word associated with the container can be “milk”. If a student will be served juice, then the word associated with the container can be “juice”.

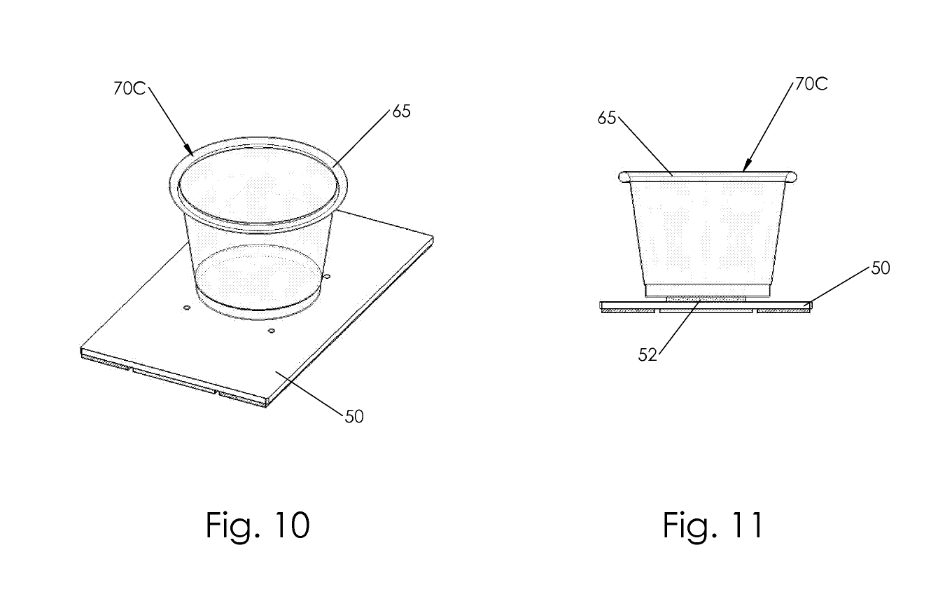

FIG. 10 is a perspective view of an exemplary specimen display assembly 70C having a cup 65 fixed to the specimen display card 50. FIG. 11 is a side elevation view of the exemplary specimen display assembly 70C of FIG. 10. In a prototype the cup 65 is a small plastic cup that is fixed to the specimen display card 50 using a specimen display mounting member 52 which is an adhesive. If desired a word or words associated with the object to be identified by the student may be presented on the first surface of the specimen display card in Braille. Some items to be taught to a student, such as spaghetti in sauce, may have a consistency that that best taught by the student directly touching the item. In such a situation a small specimen of spaghetti in sauce may be placed in the cup for the student to touch directly and respond as directed by the teacher.

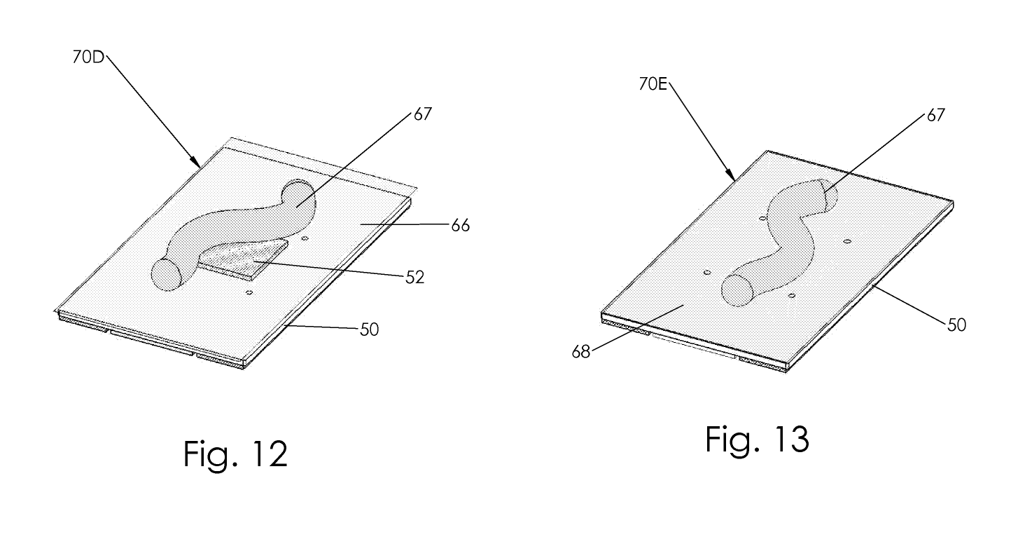

FIG. 12 is a perspective view of an exemplary specimen display assembly 70D with a specimen display card 50 having a plastic bag 66 attached to the specimen display card, the plastic bag containing a specimen such as a gummy worm 67. Preferably the plastic bag is transparent so the teacher can see the specimen in the bag. The bag is secured to the specimen display card by the specimen mounting member 52, which is an adhesive. Some items to be taught to a student, such as a gummy candy cannot easily be simulated and this configuration allows a student to feel the specimen through the bag without having access to put the specimen in his mouth. If desired a word or words associated with the object to be identified by the student may be presented on the first surface of the specimen display card in Braille.

FIG. 13 is a perspective view of an exemplary specimen display assembly 70E with specimen display card 50 having a transparent plastic film 68 attached to the specimen display card and a specimen 67 is disposed between the film and the first surface of the specimen display card. This specimen display assembly is similar to that shown and described with respect to FIG. 12 except there is no specimen display assembly used in this embodiment and the periphery of the plastic film is secured directly to the first surface of the specimen display card. If desired a word or words associated with the object to be identified by the student may be presented on the first surface of the specimen display card in Braille.

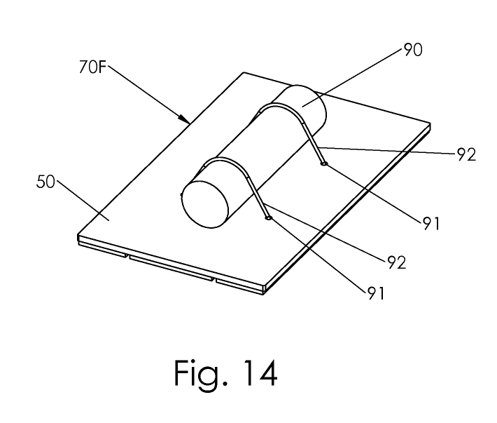

FIG. 14 is a perspective view of an exemplary specimen display assembly 70F with the specimen 90 attached to the specimen display card 50 by at least one elongated member 92. The specimen display card is provided with at least two passages 91 extending through the card, preferably four or more passages, to facilitate mounting a specimen to the display card oriented either horizontally or vertically. The object 90 is attached to the first side of the specimen display card by at least one elongated member 92 that passes through the passageways 91 and around the object and then secured to itself. The elongate member may be for example a wire twist tie or an elastomeric cable tie that passes through the two passages in the specimen display card from the back side of the card and then extends around the object and is secured to itself. A nylon cable tie is the preferred elongated member and it is understood that a nylon cable tie consists of a tape section with triangular teeth that slope in one direction. The head of the cable tie has a slot with a flexible pawl that rides up the slope of these teeth when the tape is inserted. The pawl engages the backside of these teeth to stop removal of the tape.

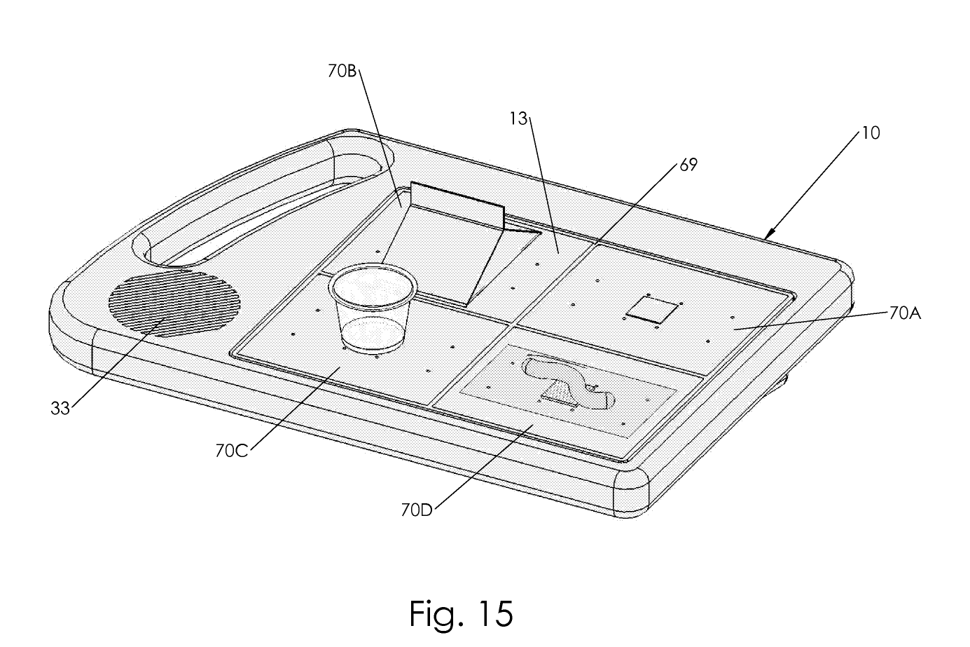

FIG. 15 is an exemplary schematic perspective view of the electronic device 10 for teaching communication of FIGS. 1 and 2 assembled with specimen display assemblies 70A, 70B, 70C and 70D of the present invention according to FIGS. 6-12. Examples of such teaching devices have been described above with respect to FIGS. 1 and 2. An electronic device 10 useful in the practice of the present invention has a touch sensitive surface and a speaker 33, the electronic device broadcasting a programmed verbal message from the speaker when a force is imparted to the touch surface. In FIG. 15 a replaceable frame 69 defines a grid of four cells, that is to say the touch screen is divided into four separate touch sensing zones. What is important is the size of the cells defined by the frame 69 will accommodate specimen display assemblies 70A, 70B, 70C and 70D according to the present invention. It has been found that first placing a sheet of magnet sensitive paper or a sheet of felt cloth over the touch sensitive surface of the electronic device, then placing the frame 69 over the paper or cloth to hold it in place against the touch sensitive surface, then placing a specimen display assembly provided on one side with either a hook material or a magnetic material in a cell defined by the frame will adequately secure the specimen display assembly in an operative location. A teacher can now prepare the electronic device 10 for use as described above. When the electronic device 10 is provided with exemplary specimen display assemblies of the present invention, a student that is totally blind or has so little vision that he or she is unable to see a printed symbol presented on a card can now touch and feel a multi-dimensional specimen, whereas such a student could not get any input from a flat card with a picture printed thereon. The specimen display cards employed with the electronic device 10 must be flexible. The second surface of the specimen display card disposed opposite the first surface, to which an object to be identified is fixed, is configured to be placed adjacent to the touch sensitive surface of the electronic device whereby pushing on the first surface of the specimen display card imparts a force to the touch surface. The student can touch and feel the upper portion of a milk or juice container of the specimen display assembly 70B, then press on the specimen display card triggering the device 10 that has been properly programmed by the teacher to broadcast the word “milk” or “juice” from the speaker 33 of the device. The student can then attempt to speak the appropriate word “milk” or “juice” that he or she has just heard spoken by the teacher's recorded voice. The student can touch and feel the cheese cracker, or simulated cheese cracker of the specimen display assembly 70A, then press on the specimen display card triggering the device 10 that has been properly programmed by the teacher to broadcast the word “cracker” or “cheese cracker” from the speaker 33 of the device. The student can then attempt to speak the appropriate word “cracker” or “cheese cracker” that he or she has just heard spoken by the teacher's recorded voice. The student can touch and feel the contents of the cup of the specimen display assembly 70C, such as spaghetti with sauce, then press on the specimen display card triggering the device 10 that has been properly programmed by the teacher to broadcast the word “spaghetti” from the speaker 33 of the device. The student can then attempt to speak the appropriate word “spaghetti” that he or she has just heard spoken by the teacher's recorded voice. The student can touch the plastic bag or sheet containing a specimen and feel through the plastic bag or sheet the specimen of the specimen display assembly 70D, such as a gummy worm, then press on the specimen display card triggering the device 10 that has been properly programmed by the teacher to broadcast the words “gummy worm” from the speaker 33 of the device. The student can then attempt to speak the appropriate words “gummy worm” that he or she has just heard spoken by the teacher's recorded voice. Of course at an appropriate time the teacher can turn off the electronic teaching device and ask the student to touch and feel the specimen display assemblies and then speak the appropriate word or words identifying the objects presented each specimen display assembly.

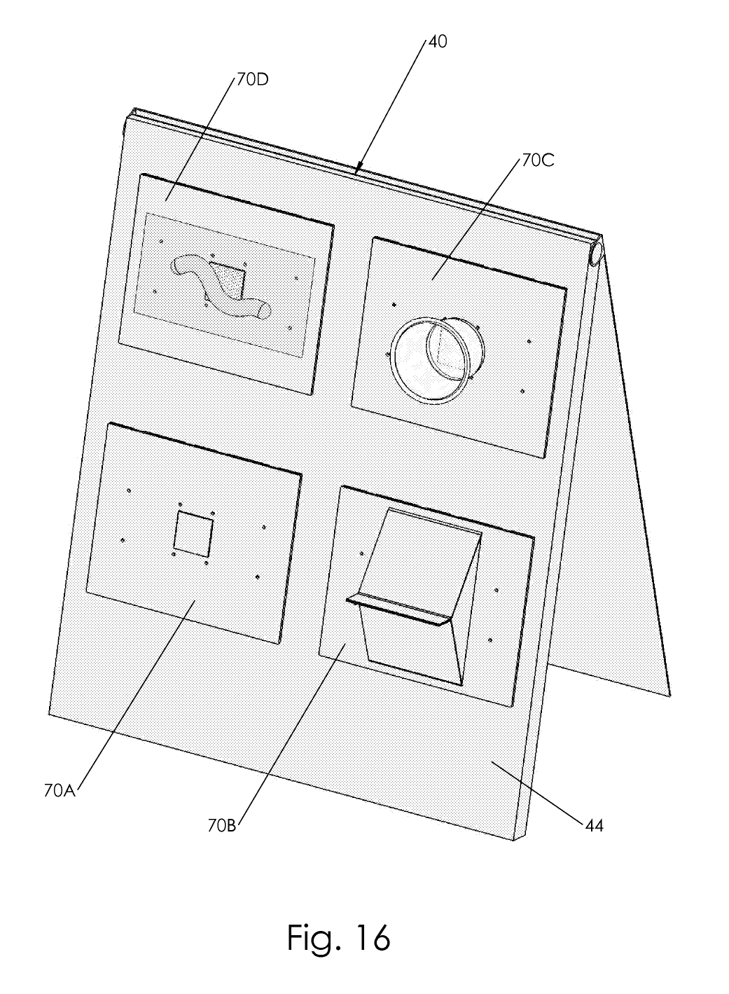

FIG. 16 is an exemplary schematic perspective view of a device, such as an easel, for teaching communication of FIG. 3 assembled with specimen display assemblies 70A, 70B, 70C and 70D of the present invention according to FIGS. 6-12. Examples of such teaching devices have been described above with respect to FIG. 3. The easel 40 is provided with a presentation member 44. The presentation member may be for example a ferrous material or may be covered with a felt fabric. It is understood that the present invention could be practiced with a presentation member supported in any desirable manner such as a frame hung on a wall. Exemplary specimen display assemblies 70A, 70B, 70C and 70D of the present invention according to FIGS. 6-12 are fixed to the presentation member of the teaching device using appropriate attachment means such as such as strips of hook material 54, 55 or an elastomeric magnetic material 56 as described above with respect to FIGS. 4 and 5. When the presentation member of the teaching device 40 is provided with specimen display assemblies of the present invention a student that is totally blind or has so little vision that he or she is unable to see a printed symbol presented on a card can now touch and feel a multi-dimensional specimen, whereas such a student could not get any input from a flat card with a picture printed thereon. The student can touch and feel the upper portion of a milk or juice container of the specimen display assembly 70B, then the teacher can speak the word “milk” or “juice”. The student can then attempt to speak the appropriate word “milk” or “juice” that he or she has just heard spoken by the teacher. The student can touch and feel the cheese cracker, or simulated cheese cracker of the specimen display assembly 70A, then the teacher can speak the word “cracker” or “cheese cracker”. The student can then attempt to speak the appropriate word “cracker” or “cheese cracker” that he or she has just heard spoken by the teacher. The student can touch and feel the contents of the cup of the specimen display assembly 70C, such as a dry item like sugar. The teacher can speak the word “sugar”. The student can then attempt to speak the word “sugar” that he or she has just heard spoken by the teacher. The student can touch the plastic bag or sheet containing or covering a specimen and feel through the plastic bag or sheet the specimen of the specimen display assembly 70D, such as a gummy worm. The teacher can speak the words “gummy worm”. The student can then attempt to speak words “gummy worm” that he or she has just heard spoken by the teacher. Of course at an appropriate time the teacher can turn off the electronic teaching device and ask the student to touch and feel the specimen display assemblies and then speak the appropriate word or words identifying the objects presented each specimen display assembly.

It is important that any communication device to be used with the specimen display cards of the present invention, which are provided with hook and loop or a magnetic attachment feature, should have an underlay of either a hook and loop receptive or magnetic receptive material so the specimen display cards will stay put on the device.

The specimen display assemblies 70a-70E that have been described herein are merely examples of an apparatus according to the present invention that may be employed as a tool for teaching verbal communication skills to a student that is totally blind or has so little vision that he or she is unable to see a printed symbol, and possibly to students that cannot readily associate visual images of symbols with words associated with those symbols. A specimen display assembly for teaching communication skills has (a) a specimen display card; (b) an object that is attached to and projects from a first surface of the specimen display card and can be felt by a student to determine what the object represents; and (c) a second surface of the specimen display card disposed opposite the first surface and being attachable to a device used for teaching communication skills.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense. It is also to be understood that the following claims are intended to cover all of the generic and specific features of the invention herein described, and all statements of the scope of the invention which, as a matter of language, might be said to fall there between.

What is claimed is:

1. An apparatus for teaching communication skills comprising
(a) a specimen display card;
(b) an object that is attached to and projects from a first surface of the specimen display card and can be felt by a student to determine what the object represents;
(c) a second surface of the specimen display card disposed opposite the first surface and being attachable to a device used for teaching communication skills.

2. The apparatus of claim 1 wherein the specimen display card is flexible.

3. The apparatus of claim 1 wherein the object that is attached to and projects from the first surface of the specimen display card simulates the feel of an item of food.

4. The apparatus of claim 1 wherein the object is attached to the first surface of the specimen display card is attached by an adhesive.

5. The apparatus of claim 1 wherein the object that is attached to and projects from the first surface of the specimen display card is a cup.

6. The apparatus of claim 1 wherein the object that is attached to and projects from the first surface of the specimen display card is a bag.

7. The apparatus of claim 6 wherein the bag contains a specimen that can be felt by a student to determine what the specimen represents.

8. The apparatus of claim 1 wherein a sheet of a film is attached to the first surface of the specimen display card and a specimen is disposed between the film and the first surface of the specimen display card.

10. The apparatus of claim 1 wherein at least one word for the object to be identified by a student is indicated on the first surface of the specimen display card in Braille.

11. The apparatus of claim 1 wherein the second surface of the specimen display card is provided with a hook material.

12. The apparatus of claim 1 wherein the second surface of the specimen display card is provided with a magnetic material.

13. The apparatus of claim 1 wherein the specimen display card is provided with at least two passages therethrough and the object is attached to the first side of the specimen display card by an elongated member that passes through the passageways and around the object and then secured to itself.

14. The apparatus of claim 1 wherein the second surface of the specimen display card is provided with a hook material and a magnetic material, and the specimen display card is provided with at least two passages therethrough.

15. A system for teaching communication skills comprising:
(a) an electronic device having a touch sensitive surface and a speaker, the electronic device broadcasting a programmed verbal message from the speaker when a force is imparted to the touch sensitive surface; and
(b) at least one apparatus that can be placed in communication with the touch sensitive surface comprising a flexible specimen display card with an object that is attached to and projects from a first surface of the specimen display card and can be felt by a student to determine what the object represents, a second surface of the specimen display card disposed opposite the first surface and being configured to be placed adjacent to the touch sensitive surface of the electronic device whereby pushing on the first surface of the specimen display card imparts a force to the touch surface.

16. A system for teaching communication skills comprising:
(a) a presentation device having a presentation member having a presentation surface; and
(b) at least one apparatus that can be placed in communication with the presentation surface of the presentation member comprising a specimen display card with an object that is attached to and projects from a first surface of the specimen display card and can be felt by a student to determine what the object represents, a second surface of the specimen display card is disposed opposite the first surface and is configured to be fixed to the presentation surface of the presentation device.

17. The system for teaching communication skills of claim 16 wherein the presentation surface of the presentation device comprises a ferrous material and the second surface of the specimen display card is provided with a magnetic material.

18. The system for teaching communication skills of claim 16 wherein the presentation surface of the presentation device comprises a fabric that is a loop material and the second surface of the specimen display card is provided with a hook material.
